(19) United States
(12) Patent Application Publication
(10) Pub. No.: US 2024/0022291 A1
(43) Pub. Date: Jan. 18, 2024

(54) CHANNEL STATE VARIATION ESTIMATION AND SINR PENALTY COMPUTATION FOR MU-MIMO PAIRING

(71) Applicant: Telefonaktiebolaget LM Ericsson (publ), Stockholm (SE)

(72) Inventors: Amr EL-KEYI, Kanata (CA); Chandra BONTU, Nepean (CA)

(21) Appl. No.: 18/249,850

(22) PCT Filed: Oct. 22, 2020
(86) PCT No.: PCT/IB2020/059954

§ 371 Date: Apr. 20, 2023

(51) Int. Cl. H04B 7/0452; H04W 4/08; H04L 25/02

(52) U.S. Cl. CPC H04B 7/0452; H04W 4/08; H04L 25/0204; H04L 25/0222

(57) ABSTRACT

According to one or more embodiments, a network node is provided. The network node includes processing circuitry configured to: determine a subset of a plurality of candidate wireless devices for Multiple-Input Multiple-Output, MIMO, grouping based at least on an information carrying capacity, ICC, of a MIMO transmission to the MIMO grouping; and cause the MIMO transmission to the MIMO grouping.

### TECHNICAL FIELD

Wireless communications and in particular, to Multiple-Input Multiple-Output, MIMO, grouping based at least on an information carrying capacity, ICC.

### BACKGROUND

Massive multiple input multiple output (MIMO) transmission helps enable enhanced spectral efficiency using spatial multiplexing. The wireless devices within a multiuser (MU)-MIMO user (i.e., wireless device) group may be selected such that they have good spatial separation, thereby allowing for the spatial multiplexing capabilities of the system to be fully exploited. Multi-user transmission can be achieved via precoding the downlink transmissions such that the mutual interference among different transmission layers is eliminated or reduced. The total throughput achieved by MU-MIMO transmission may depend on any one of the number of multiplexed wireless devices, the signal-to-interference (SNR) of each wireless device and the accuracy of the inter-wireless device interference suppression precoding algorithm. Increasing the number of paired wireless devices does not necessarily lead to increasing the cell throughput since the transmission power is shared between the MU-MIMO multiplexed wireless devices and residual mutual MU-MIMO interference increases as the number of paired wireless devices increases.

Further, in reciprocity-based downlink transmission schemes, the MU-MIMO precoders are designed based on channel estimates obtained from uplink reference symbols that are transmitted by the wireless device in prior uplink transmission slots. As the speed of the wireless devices increases and/or as the period of uplink reference symbols transmission increases, the accuracy of the channel estimates degrades, which may negatively lead to increased MU-MIMO leakage interference.

However, existing examples for MU-MIMO group selection depend on a spatial separability test without taking into consideration the channel variation rate of the wireless devices and/or their signal to noise ratio (SNR). As a result, spatial separation MU-MIMO grouping does not necessarily yield the maximum achievable downlink MU-MIMO cell throughput such as when wireless devices with high mobility and/or low SNR are included in a MU-MIMO transmission group.

### SUMMARY

Some embodiments advantageously provide a method and system for Multiple-Input Multiple-Output, MIMO, grouping based at least on an information carrying capacity, ICC.

One or more embodiments of the instant disclosure utilize channel estimates for estimating a channel variation coefficient for each wireless device, where each channel variation coefficient indicates the rate of change in the channel state. The wireless device channel variation rate and SNR estimates are used to compute the signal to interference-plus-noise (SINR) and information carrying capacity (ICC) of the downlink MU-MIMO transmission. In one or more embodiments, MU-MIMO grouping is performed based on the spatial separability of the wireless devices as well as ICC improvement testing that is described herein. In particular, the wireless device is added to the MU-MIMO group if and only if the ICC of the downlink transmission improves after the wireless device is added. The ICC is determined, e.g., calculated, based on the current number of MU-MIMO layers in the MU-MIMO group, and the channel variation rate of different wireless devices as well as their estimated SNR.

System-level simulation results described herein illustrate that significant improvement in downlink cell throughput can be achieved by the MU-MIMO grouping algorithm/method(s) described herein when compared to legacy, i.e., known, spatial separation-based grouping.

According to one aspect of the disclosure, a network node is provided. The network node includes processing circuitry configured to: determine a subset of a plurality of candidate wireless devices (22) for Multiple-Input Multiple-Output, MIMO, grouping based at least on an information carrying capacity, ICC, of a MIMO transmission to the MIMO grouping; and cause the MIMO transmission to the MIMO grouping.

According to one or more embodiments of this aspect, the determining of the subset of the plurality of candidate wireless devices is based at least on spatial separability of the plurality of candidate wireless devices. According to one or more embodiments of this aspect, the plurality of candidate wireless devices are associated with pairwise spatial metrics that meet a spatial pairing threshold. According to one or more embodiments of this aspect, the processing circuitry is configured to determine the ICC based at least on a channel variation coefficient for each of the plurality of candidate wireless devices.

According to one or more embodiments of this aspect, the channel variation coefficient indicates a rate of change in a communication channel state. According to one or more embodiments of this aspect, the processing circuitry is configured to determine the ICC based at least on mobility estimates of the plurality of candidate wireless devices. According to one or more embodiments of this aspect, the mobility estimates are based on temporal filtering of a correlation coefficient between channel estimates at successive channel estimation instants. According to one or more embodiments of this aspect, the processing circuitry is configured to determine the ICC based at least on respective signal to noise ratio, SNR, of the plurality of candidate wireless devices.

According to one or more embodiments of this aspect, the processing circuitry is configured to determine the ICC based at least on inter-wireless device interference among the plurality of candidate wireless devices. According to one or more embodiments of this aspect, the processing circuitry is configured to: determine a total ICC for a first group of the plurality of candidate wireless devices; modify the first group by logically adding a first wireless device of the plurality of candidate wireless devices to the first group; determine the total ICC for the modified first group; add the first wireless device to the subset of the plurality of candidate wireless devices based on the total ICC of the modified first group being greater than the total ICC of the first group; and remove the first wireless device from the modified first group of the plurality of candidate wireless devices based on the total ICC of the modified first group being less than the total ICC of the first group. According to one or more embodiments of this aspect, the ICC corresponds to a number of bits that are transmittable per second per resource while meeting a target bit error rate.

According to another aspect of the disclosure, a method implemented by a network node is provided. A subset of a plurality of candidate wireless devices for Multiple-Input Multiple-Output, MIMO, grouping is determined based at least on an information carrying capacity, ICC, of a MIMO transmission to the MIMO grouping. The MIMO transmission is caused to the MIMO grouping.

According to one or more embodiments of this aspect, the determining of the subset of the plurality of candidate wireless devices is based at least on spatial separability of the plurality of candidate wireless devices. According to one or more embodiments of this aspect, the plurality of candidate wireless devices are associated with pairwise spatial metrics that meet a spatial pairing threshold. According to one or more embodiments of this aspect, the ICC is determined based at least on a channel variation coefficient for each of the plurality of candidate wireless devices. According to one or more embodiments of this aspect, the channel variation coefficient indicates a rate of change in a communication channel state.

According to one or more embodiments of this aspect, the ICC is determined based at least on mobility estimates of the plurality of candidate wireless devices. According to one or more embodiments of this aspect, the mobility estimates are based on temporal filtering of a correlation coefficient between channel estimates at successive channel estimation instants. According to one or more embodiments of this aspect, the ICC is determined based at least on respective signal to noise ratio, SNR, of the plurality of candidate wireless devices.

According to one or more embodiments of this aspect, the ICC is determined based at least on inter-wireless device interference among the plurality of candidate wireless devices. According to one or more embodiments of this aspect, a total ICC for a first group of the plurality of candidate wireless devices is determined. The first group is modified by logically adding a first wireless device of the plurality of candidate wireless devices to the first group. The total ICC for the modified first group is determined. The first wireless device is added to the subset of the plurality of candidate wireless devices based on the total ICC of the modified first group being greater than the total ICC of the first group. The first wireless device is removed from the modified first group of the plurality of candidate wireless devices based on the total ICC of the modified first group being less than the total ICC of the first group. According to one or more embodiments of this aspect, the ICC corresponds to a number of bits that are transmittable per second per resource while meeting a target bit error rate.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of another process in the network node according to some embodiments of the present disclosure;

FIG. 9 is a flowchart of another example process in the network node according to some embodiments of the present disclosure;

FIG. 10 is a flowchart of another example process in the network node according to some embodiments of the present disclosure;

FIG. 11. is a flowchart of another example process in the network node according to some embodiments of the present disclosure;

FIG. 12 is a diagram illustrating the downlink cell throughput of the MU-MIMO grouping algorithm for various speeds according to embodiments of the present disclosure;

FIG. 13 is a diagram illustrating downlink cell throughput versus number of wireless devices according to embodiments of the present disclosure; and

FIG. 14 is a diagram illustrating a number of MU-MIMO layers versus a number of wireless devices according to embodiments of the present disclosure.

### DETAILED DESCRIPTION

While existing systems provide MU-MIMO grouping using a spatial separability test, these existing systems fail to consider the rate of channel variation of the wireless devices and the rate of acquisition of channel state estimates when the wireless devices are selected for MU-MIMO co-scheduling. This disadvantageously limits the benefits MU-MIMO grouping. One or more embodiments of the instant disclosure advantageously solve one or more problems with existing systems at least by performing MU-MIMO grouping based on a wireless device channel variation rate and/or SNR estimates, as well as, for example, based on spatial separability. The instant disclosure is able to provide for improvement in downlink cell throughput in MU-MIMO grouping when compared to legacy spatial separation based grouping, as described herein.

Before describing in detail exemplary embodiments, it is noted that the embodiments reside primarily in combinations of apparatus components and processing steps related to Multiple-Input Multiple-Output, MIMO, grouping based at least on an information carrying capacity, ICC. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide Multiple-Input Multiple-Output, MIMO, grouping based at least on an information carrying capacity, ICC.

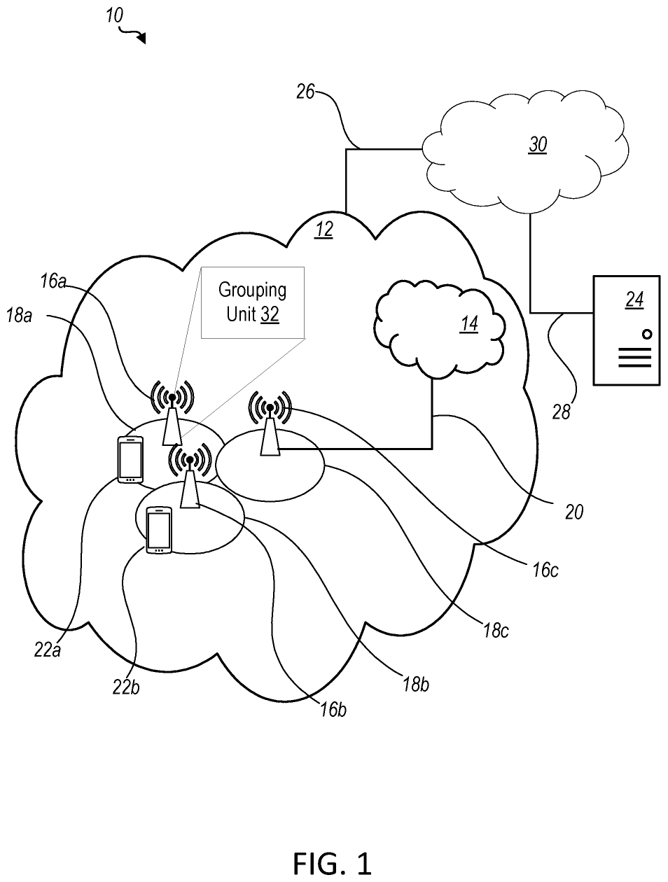

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a grouping unit 32 which is configured to perform one or more network node 16 functions as described herein such as with respect to MIMO grouping based at least on ICC.

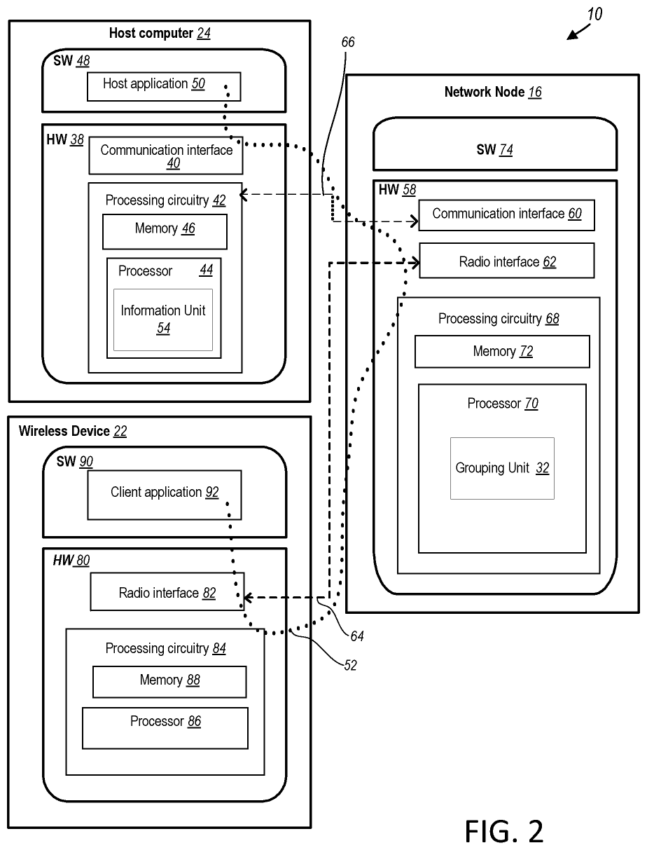

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to process, analyze, store, transmit, receive, determine, relay, forward, indicate, etc., information related to MIMO grouping based at least on ICC.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include grouping unit 32 configured to perform one or more network node 16 functions as described herein such as with respect to MIMO grouping based at least on ICC.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 shows a “unit” such as grouping unit 32 as being within processor 70, it is contemplated that this and/or other units may be implemented such that a portion of the unit is stored in a corresponding memory within the processing circuitry. In other words, the units may be implemented in hardware or in a combination of hardware and software within the processing circuitry.

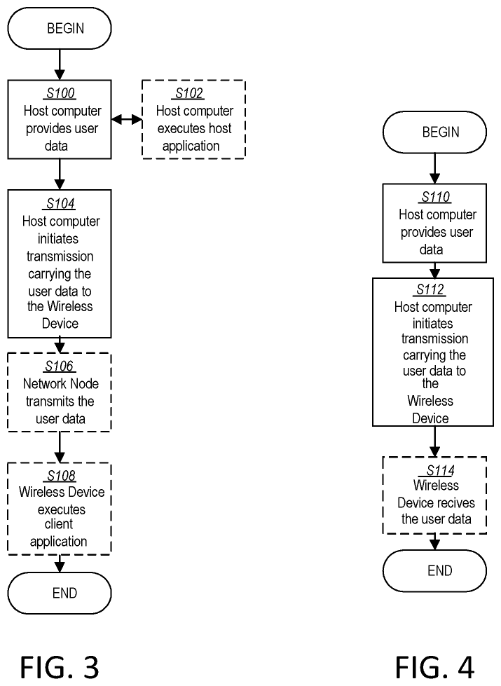

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

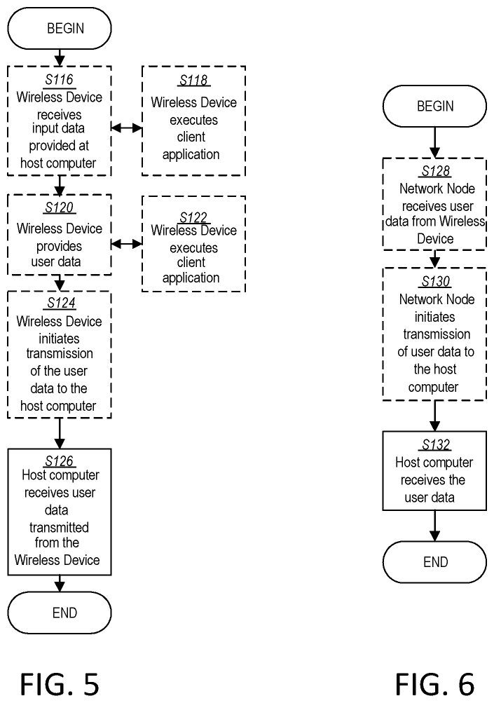

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

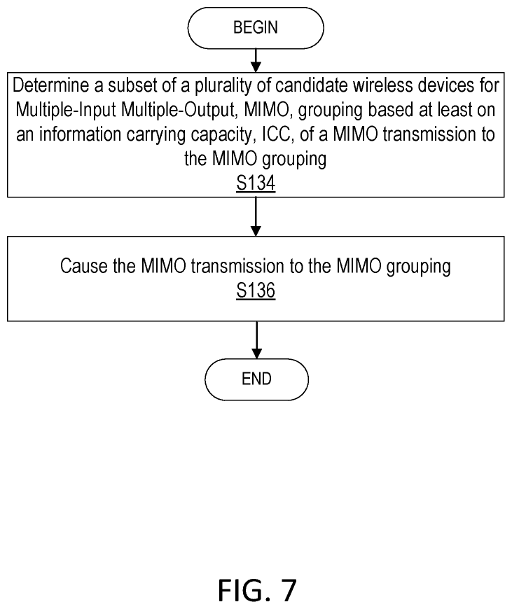

FIG. 7 is a flowchart of an example process in a network node 16 according to some embodiments of the present disclosure. One or more Blocks and/or functions performed by network node 16 may be performed by one or more elements of network node 16 such as by grouping unit 32 in processing circuitry 68, processor 70, radio interface 62, etc. In one or more embodiments, network node 16 such as via one or more of processing circuitry 68, processor 70, grouping unit 32, communication interface 60 and radio interface 62 is configured to determine (Block S134) a subset of a plurality of candidate wireless devices 22 for Multiple-Input Multiple-Output, MIMO, grouping based at least on an information carrying capacity, ICC, of a MIMO transmission (e.g., MIMO transmission configuration for transmission) to the MIMO grouping, as described herein. In one or more embodiments, network node 16 such as via one or more of processing circuitry 68, processor 70, grouping unit 32, communication interface 60 and radio interface 62 is configured to cause (Block S136) the MIMO transmission to the MIMO grouping, as described herein. MIMO transmission to be transmitted by refer to MIMO transmission according to a MIMO transmission configuration of a subset of the plurality of candidate wireless device 22 determined at Block S134.

According to one or more embodiments, the determining of the subset of the plurality of candidate wireless devices 22 is based at least on spatial separability of the plurality of candidate wireless devices 22. According to one or more embodiments, the plurality of candidate wireless devices 22 are associated with pairwise spatial metrics that meet a spatial pairing threshold. According to one or more embodiments, the processing circuitry 68 is configured to determine the ICC based at least on a channel variation coefficient for each of the plurality of candidate wireless devices 22.

According to one or more embodiments, the channel variation coefficient indicates a rate of change in a communication channel state. According to one or more embodiments, the processing circuitry 68 is configured to determine the ICC based at least on mobility estimates of the plurality of candidate wireless devices 22. According to one or more embodiments, the mobility estimates are based on temporal filtering of a correlation coefficient between channel estimates at successive channel estimation instants.

According to one or more embodiments, the processing circuitry 68 is configured to determine the ICC based at least on respective signal to noise ratio, SNR, of the plurality of candidate wireless devices 22. According to one or more embodiments, the processing circuitry 68 is configured to determine the ICC based at least on inter-wireless device 22 interference among the plurality of candidate wireless devices 22. According to one or more embodiments, the processing circuitry 68 is configured to: determine a total ICC for a first group of the plurality of candidate wireless devices 22; modify the first group by logically adding a first wireless device 22 of the plurality of candidate wireless devices 22 to the first group; determine the total ICC for the modified first group; add the first wireless device 22 to the subset of the plurality of candidate wireless 22 device based on the total ICC of the modified first group being greater than the total ICC of the first group; and remove the first wireless device 22 from the modified first group of the plurality of candidate wireless device 22 based on the total ICC of the modified first group being less than the total ICC of the first group. According to one or more embodiments, the ICC corresponds to a number of bits that are transmittable per second per resource while meeting a target bit error rate.

Having generally described arrangements for MIMO grouping based at least on ICC, functions and processes are provided as follows, and which may be implemented by the network node 16, wireless device 22 and/or host computer 24. Some embodiments provide arrangements for MIMO grouping based at least on ICC.

System Description

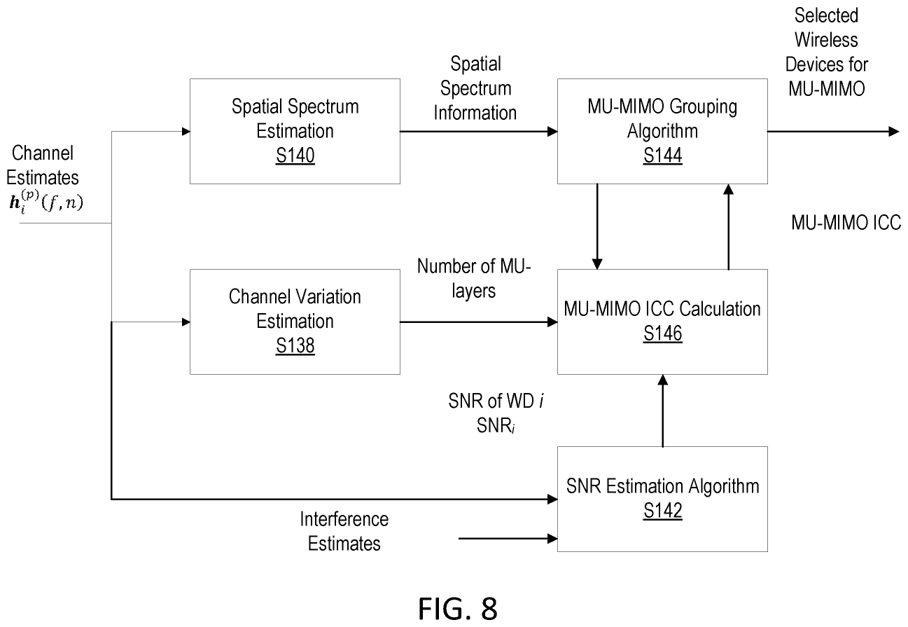

In one or more embodiments, a system 10 for selecting the wireless devices 22 in a MU-MIMO group together is provided where the selection is based on one or more algorithms that may be utilized by one or more components of system 10. FIG. 8 is a block diagram another example of the MU-MIMO pairing algorithm in accordance with the teachings of the present disclosure. The network node 16 such as via one or more of processing circuitry 68, processor 70, radio interface 62, grouping unit 32, etc., utilizes the channel estimates for estimating a channel variation coefficient for each wireless device 22 that indicates the rate of change of the channel state (Block S138). In addition, the channel estimates are utilized for estimating the spatial spectrum such as via one or more of processing circuitry 68, processor 70, radio interface 62, grouping unit 32, etc., (Block S140), e.g., using the one or more spatial estimation algorithms known in the art, as well as for estimating the received signal power at the wireless device 22 to determine the SNR (i.e., an example of a signal or channel characteristics)(Block S142). That is, the MU-MIMO grouping may be performed such as via one or more of processing circuitry 68, processor 70, radio interface 62, grouping unit 32, etc., based at least on the spatial separability of the wireless devices 22 which can be determined from the spatial spectrum. In addition to spatial separation testing, in one or more embodiments, wireless device 22 is added to the MU-MIMO group if and only if the sum ICC of the downlink transmission of the MU-MIMO group improves after wireless device 22 is added (Block S144). The ICC is determined given the current number of MU-MIMO layers in the MU-MIMO group (Block S146), and the channel variation rate estimate for different wireless device 22 as well as their estimated SNR. One or more algorithms used in different sub-blocks of the system are described below.

Channel Variation Estimation

In one or more embodiments, it may be assumed that network node 16, such as via one or more of processing circuitry 68, processor 70, radio interface 62, grouping unit 32, etc., is employing an N-element antenna array for communicating with multiple wireless devices 22. Let the Mᵢ×N matrix Hᵢ(f,n) denote the matrix containing the coefficients of the downlink channel state to wireless device i (i.e., wireless device 22i) from network node 16 at frequency f and time instant n where ML is the number of receive antennas at wireless device 22. In time-division duplex systems where channel reciprocity can be assumed, the channel estimates are available at network node 16, e.g., from uplink channel sounding transmissions, and are used by network node 16, such as via one or more of processing circuitry 68, processor 70, radio interface 62, grouping unit 32, etc., to select beamforming coefficients to transmit downlink data. The channel estimates can also be obtained using quantized feedback from the wireless device 22 to be used by network node 16 in downlink beamforming, e.g., Type 1 and Type 2 codebook-based beamforming in NR. In one or more embodiments, the channel variation estimation for downlink channel state matrices is considered. Nevertheless, one or more algorithms described herein can be directly extended to other types of channel state information.

In one or more embodiments, it is assumed that the channel state evolves according to a first-order auto-regressive (AR) model. For simplicity, a first-order AR model is considered. However, the channel variation estimation algorithm (e.g., as used in Block S138) can also be extended to include higher-order AR and state-space models. Using the first-order model AR model, the channel state evolution in time may be written/expressed as

Hᵢ(f,n)=αᵢHᵢ(f,n−1)+νᵢ(f,n)

where αᵢ is a complex scalar, vᵢ(f,n) is circular Gaussian random matrix with independent identically distributed entries each of variance σᵥ_{ᵢ}² where

σ_{ν}_{ᵢ}²=σₕ_{ᵢ}²(1−|αᵢ|²)

and σₕ_{ᵢ}² is the variance of each element of Hᵢ(f,t).

The parameter αᵢ can be estimated using the Yule-Walker equations as

$${\hat{α}}_{i} = \frac{{r}_{i} ( 1 )}{{r}_{i} ( 0 )}$$

where rᵢ(k) is the autocovariance of each element of Hᵢ(f,n) at lag k.

Let the 1×N vector hᵢ^{(p)}(f,n) denote the downlink channel from network node 16 to antenna p of wireless device i at frequency f and time instant n, i.e.,

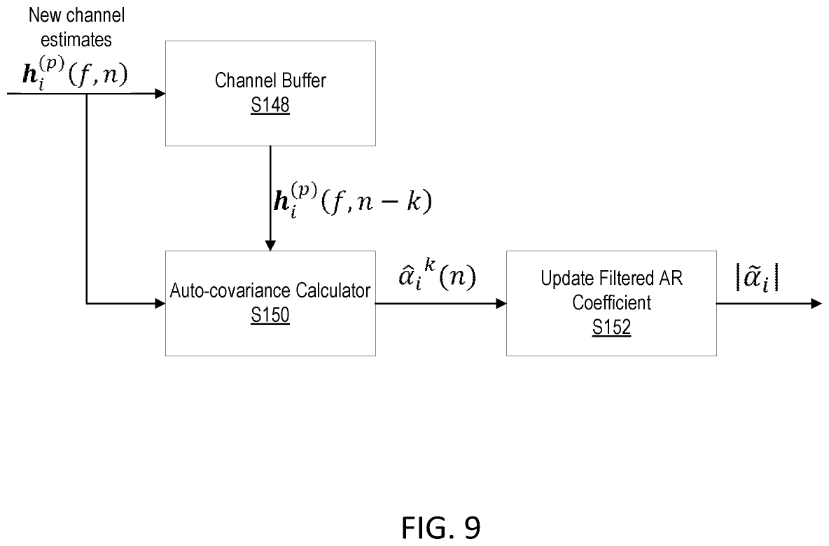

Hᵢ(f,n)=[hᵢ⁽⁰⁾^{^{T}}(f,n)hᵢ⁽¹⁾^{^{T}}(f,n) . . . hᵢ^{(M}^{ᵢ}⁾^{^{T}}(f,n)]^{T}

where ( )^{T} denotes the transpose operator. FIG. 9 is a block diagram of one example of a channel variation estimation algorithm in accordance with the principles of the present disclosure, i.e., an example of channel variation estimation of Block S138. Let \hat{α}ᵢ(n) denote the estimate of al at time instant n, given the channel estimates from the same antenna p of wireless device i at time n−k and n, i.e., hᵢ^{(p)}(f,n) and hᵢ^{(p)}((f,n−k) that may be stored in channel buffer (Block S148), \hat{α}ᵢ^{k}(n) is estimated from the Yule-Walker equations by calculating the auto-covariance (Block S150) via frequency averaging, i.e.,

$${\hat{α}}_{i}^{k} ( n ) = \frac{{\sum }_{f} {h}_{i}^{( p )} ( f , n ) {h}_{i}^{{( p )}^{H}} ( f , n - k )}{\sqrt{{\sum }_{f} {‖ {h}_{i}^{( p )} ( f , n - k ) ‖}^{2}} \sqrt{{\sum }_{f} {‖ {h}_{i}^{( p )} ( f , n ) ‖}^{2}}}$$

where ∥·∥ denotes the vector norm operator, |·| denotes the magnitude of a complex number and ( )^{H} denotes the Hermitian transpose operator. Next the magnitude of the AR model |\hat{α}ᵢ(n) is computed from the estimated \hat{α}ᵢ^{k}(n) by taking the k-th root of \hat{α}ᵢ^{k}(n) and temporal filtering is applied to smooth out the estimated value to obtain the filtered estimate |\tilde{α}ᵢ| (Block S152). For example, a first-order low pass filter may be used to update |\tilde{α}ᵢ| as

|\tilde{α}ᵢ|:=β|\tilde{α}ᵢ|+(1−β)|\hat{α}(n)|

where:=indicates the assignment operator,

$$β = {e}^{- \frac{n - {n}_{0}}{W}} ,$$

n₀ is the subframe index of last update of |\hat{α}ᵢ(n)|, and W is the effective memory length of the filter.

MU-MIMO SINR Penalty Determination

In downlink MU-MIMO transmission mode, multiple wireless devices 22 can be co-scheduled on the same resources and the downlink beamforming coefficients may be selected to suppress inter-user interference between the co-scheduled wireless devices 22. For simplicity, it may be assumed that each wireless device 22 is equipped with 1 antenna, i.e., Mᵢ=1. For example, when L wireless devices 22 are paired in a MU-MIMO transmission with one-layer transmission per wireless device 22, the downlink MU-MIMO beamformer at time instant n and frequency f is given by the N×L matrix

W(f,n)=Ĥ^{H}(f,n)(Ĥ(f,n)Ĥ^{H}(f,n)+δ²I_{L})⁻¹

where I_{L} is the L×L identity matrix, δ² is the interference-plus-noise estimate and the L×N matrix Ĥ(f,t) is given by

Ĥ(f,t)=[ĥ₀⁽⁰⁾^{^{T}}(f,n)ĥ₁⁽⁰⁾^{^{T}}(f,n) . . . ĥ_{L-1}⁽⁰⁾^{^{T}}(f,n)]^{T}

where ĥₖ^{(p)}(f,n) is the 1×N vector containing the estimate of ĥₖ^{(p)}(f,n) available at the network node 16 at time n. This estimate might be different from the actual channel due to wireless device 22 mobility and the fact that the channel estimates are obtained from earlier uplink transmissions. Note that the term (Ĥ(f,n)Ĥ^{H}(f,n)+δ²I_{L})⁻¹ in the above expression is responsible for suppressing the inter-wireless device interference while the term Ĥ^{H}(f,t) is equivalent to matched filtering beamforming in the directions of channels of the paired wireless devices 22. Hence, the inter-wireless device interference suppression might not suppress all interference due to channel estimation errors leading to residual leakage interference between the multiplexed wireless devices 22.

An approximation for the reduction in the signal to interference-plus-noise ratio (SINR) at wireless device 22 due to channel estimation errors will be described. For simplicity, the zero-forcing precoder is considered which is given by the N×L matrix W(f,t)=Ĥ^{†}(f,t) where (·)^{†} denotes the pseudoinverse operator i.e., Ĥ^{†}(f,t)=Ĥ^{H}(f,t) (Ĥ(f,t)Ĥ^{H}(f,t))⁻¹ and the residual MU-MIMO interference and desired signal power loss due to errors in Ĥ^{†}(f,t) is evaluated. It is assumed that each channel estimate has an error, e.g., due to mobility of, for example, wireless device 22. Hence, the 1×N downlink channel vector for wireless device i is given by

ĥᵢ=hᵢ+eᵢ

where eᵢ is the 1×N vector containing the error in the channel vector estimate for wireless device i and the frequency and time indices have been dropped as well as the index of the wireless device antenna for simplicity. It is assumed that eᵢ is circular Gaussian random variable with covariance σₑ_{ᵢ}²I. The received signal at wireless device i is given by

yᵢ=hᵢĤ^{†}s+nᵢ

where s=[s₀ . . . s_{L-1}]^{T} is the L×1 transmitted symbol vector for the MU-paired wireless devices and nᵢ is the AWGN at user wireless device i, i.e., nᵢ˜ [symbol] [symbol] (0,σ_{n,i}²). Let us define the N×L matrix E=[e₀^{T} . . . e_{L-1}^{T}]^{T}, hence, Ĥ=H+E. Using the first-order Taylor expansion for the pseudo-inverse given by

Ĥ^{†}≈H^{†}−H^{†}EH^{†}

the received signal at wireless device i is approximated as

yᵢ≈hᵢH^{†}s−hᵢH^{†}EH^{†}s+nᵢ.

Note that the second term in the above expression contains the interference due to leakage from MU-MIMO transmissions to the L−1 wireless devices paired with wireless device i. The power of the interference on wireless device i due to MU-MIMO leakage can be computed as

Iᵢ=E{|eᵢH^{†}Σ_{j≠i}uⱼsⱼ|²},

where uⱼ is the L×1 unit vector in direction j and E{ } denotes the statistical expectation. The following has been used: hᵢH^{†}=uᵢ^{T}E=eᵢ and expanded s as s=Σⱼuⱼsⱼ. The expression for Iᵢ can be expanded as

$${I}_{i} = E \{ t r \{ ( {\sum }_{j \neq i} {u}_{j} {s}_{j} ) ( {\sum }_{k \neq i} {u}_{k}^{T} {s}_{k}^{*} ) {H}^{{†}^{H}} {e}_{i}^{H} {e}_{i} {H}^{†} \} \} ,$$

where tr{ } denotes the trace of a matrix and ( )* denotes the complex conjugate operator. Note that the transmitted symbols are independent, i.e., E{(Σ_{j≠i}uⱼsⱼ)(Σ_{k≠i}uₖ^{T}sₖ*)}=Σ_{j≠i}uⱼ^{T}Pⱼ where Pⱼ is the power allocation for the symbols of wireless device j, i.e., E{|sⱼ|²}=Pⱼ. Furthermore, E{eᵢ^{H}eᵢ}=σₑ_{ᵢ}²I and H^{†}^{^{H}}H^{†}=(H H^{H})⁻¹. Hence, the above expression for Iᵢ can be simplified as

$${I}_{i} = {σ}_{{e}_{i}}^{2} {\sum }_{j \neq i} {[ {( \hat{H} {\hat{H}}^{H} )}^{- 1} ]}_{j , j} {P}_{j}$$

where [A]_{m,n} denotes the element in row m and column n of the matrix A.
In order to further simplify the expression for the leakage interference, it is assumed that the power is equally distributed among all transmitted layers, i.e., Pⱼ=P and it is further assumed that the paired wireless devices 22 have been properly selected such that hᵢhⱼ^{H}<<σₕ_{ⱼ}σₕ_{ⱼ} where σₕ_{ⱼ}²=E{hⱼhⱼ^{H}}, i.e., the channels of different wireless device 22 are almost orthogonal. Hence, all the significant values of the matrix ĤĤ^{H} are located on the main diagonal only. Furthermore, it is assumed that σₕ_{ⱼ}² are approximately equal for all the paired wireless device 22, i.e., the paired wireless devices 22 have similar long-term fading statistics. Hence, the interference on wireless device i due to MU-MIMO leakage can be approximated as

$${I}_{i} \approx {σ}_{{e}_{i}}^{2} ( L - 1 ) \frac{P}{N {σ}_{{h}_{i}}^{2}}$$

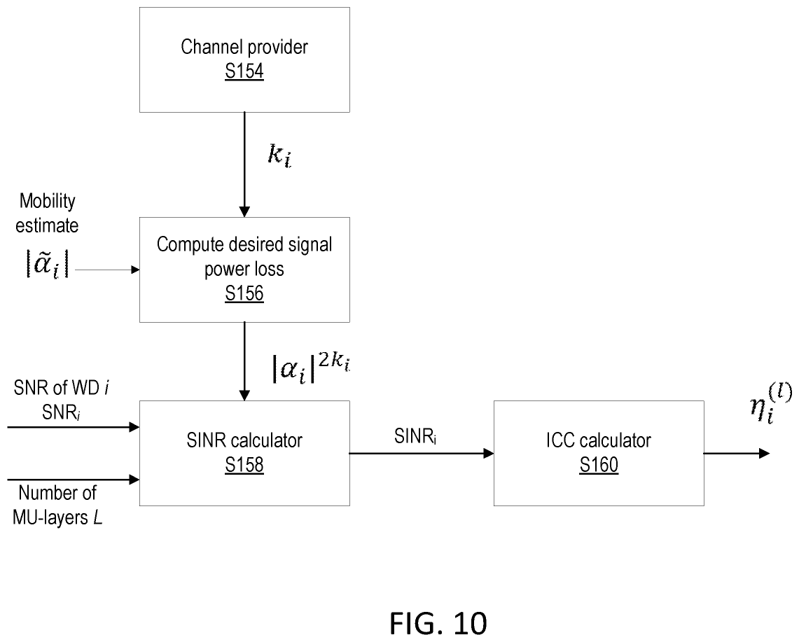

Recall that σₑ_{ᵢ}² represents the power of the error in the channel estimate of wireless device i. FIG. 10 is a block diagram of an example of the ICC computation algorithm. Using the AR1 model, σₑ_{ᵢ}²=σₕ_{ᵢ}²(1−|αᵢ|^{2k}^{ᵢ}) where kᵢ is the number of time slots since the latest estimate of the channel for wireless device i was obtained where kᵢ may be provided by the channel provider (Block S154). In the analysis so far, it has been assumed that all the wireless devices 22 have a single antenna, and hence, there the wireless devices 22 have no interference rejection capability. Nevertheless, when wireless device i is equipped with Mᵢ>1 antennas, it can suppress Mᵢ−1 of the interfering L−1 layers of the paired wireless device 22. Hence, a fraction (L−Mᵢ/(L−1) of the interference is unsuppressed and Iᵢ can be approximated as

$${I}_{i} \approx \frac{L - {M}_{i}}{N} ( 1 - {\vert {α}_{i} \vert}^{2 {k}_{i}} ) P$$

In addition to interference due to MU-MIMO leakage, the received desired signal power degrades due to errors in the channel estimates. Using the AR1 model for the channel, the received signal power degrades by a factor of |αᵢ|^{2k}^{ᵢ}, which may be computed based on a mobility estimate (Block S156). Therefore, the received SINR at wireless device i while considering the effect of wireless device channel variation may be expressed as

$${SINR}_{i} = \frac{{\vert {α}_{i} \vert}^{2 {k}_{i}} P}{{I}_{i} + {σ}_{n , i}^{2}} = {\vert {α}_{i} \vert}^{2 {k}_{i}} {( \frac{{σ}_{n , i}^{2}}{P} + \frac{{I}_{i}}{P} )}^{- 1}$$

$$= {\vert {α}_{i} \vert}^{2 {k}_{i}} {( \frac{1}{S N {R}_{i}} + ( \frac{L - {M}_{i}}{N} ) ( 1 - {\vert {α}_{i} \vert}^{2 {k}_{i}} ) )}^{- 1}$$

where

$$S N {R}_{i} = \frac{P}{{σ}_{n , i}^{2}}$$

is the SNR of wireless device i without considering the effect of channel variation. That is, in one or more embodiments, SINRᵢ is determined based on the SNR of WD i (SNRᵢ) and a number of MU-layers L (Block S158).

ICC-Based Pairing Test

The information carrying capacity (ICC) of the downlink can be computed from the SINR (Block S160). Let SINRᵢ^{(l)}(f,n) denote the SINR of wireless device i at frequency f and time instant n while considering the effect of channel variation and assuming it is paired in a MU-MIMO transmission with l layers. In particular,

$${SINR}_{i}^{( l )} ( f , n ) = {\vert {α}_{i} \vert}^{2 {k}_{i}} {( \frac{l}{S N {R}_{i}^{( SU )} ( f , n )} + ( \frac{l - {M}_{i}}{N} ) ( 1 - {\vert {α}_{i} \vert}^{2 {k}_{i}} ) )}^{- 1}$$

where SNRᵢ^{(SU)}(f,n) is the SNR of wireless device i at frequency f and time instant n without considering the effect of channel variation and assuming SU-MIMO transmission. The ICC can be computed such as via one or more of processing circuitry 68, processor 70, radio interface 62, grouping unit 32, etc., by mapping the SINR for each frequency to the corresponding ICC for the target block error rate, e.g., using Shannon capacity formula for an additive white Gaussian channel and error-free reception, the total ICC for wireless device i at time instant n when paired in a MU-MIMO transmission with l layers is given by

$${η}_{i}^{( l )} ( n ) = {\sum }_{f} log ( 1 + {SINR}_{i}^{( l )} ( f , n ) )$$

Given that wireless device 0, 1, . . . , k−1 are in MU-MIMO group, the total ICC of the MU-MIMO transmission at time instant n is given by

$${η}_{0 , 1 , … , k - 1} ( n ) = {\sum }_{i = 0}^{k - 1} {η}_{i}^{( k )} ( n )$$

The ICC improvement pairing test for adding wireless device k to the MU-MIMO group can be performed by computing the ICC for the MU-MIMO group including wireless device k as

$${η}_{0 , 1 , … , k - 1 , k} ( n ) = {\sum }_{i = 0}^{k} {η}_{i}^{( k + 1 )} ( n )$$

Note that ηᵢ^{(k+1)}(n)≤ηᵢ^{(k)}(n) due to power sharing and additional interference leakage due to channel variation of wireless device k. Hence, wireless device k can be added such as via one or more of processing circuitry 68, processor 70, radio interface 62, grouping unit 32, etc., to the MU-MIMO group if

η_{0,1, . . . ,k-1,k}(n)>η_{0,1, . . . ,k-1}(n).

In one or more embodiments, the ICC-based pairing test can be integrated with other MU-MIMO pairing algorithms as a final step before adding a wireless device 22 to the MU-MIMO group. For example, the ICC test can be integrated into a known iterative MU-MIMO pairing algorithm that may be performed such as via one or more of processing circuitry 68, processor 70, radio interface 62, grouping unit 32, etc. That is, one or more known MU-MIMO pairing algorithms may be modified to include the ICC test as described herein such as to provide one or more advantages described herein.

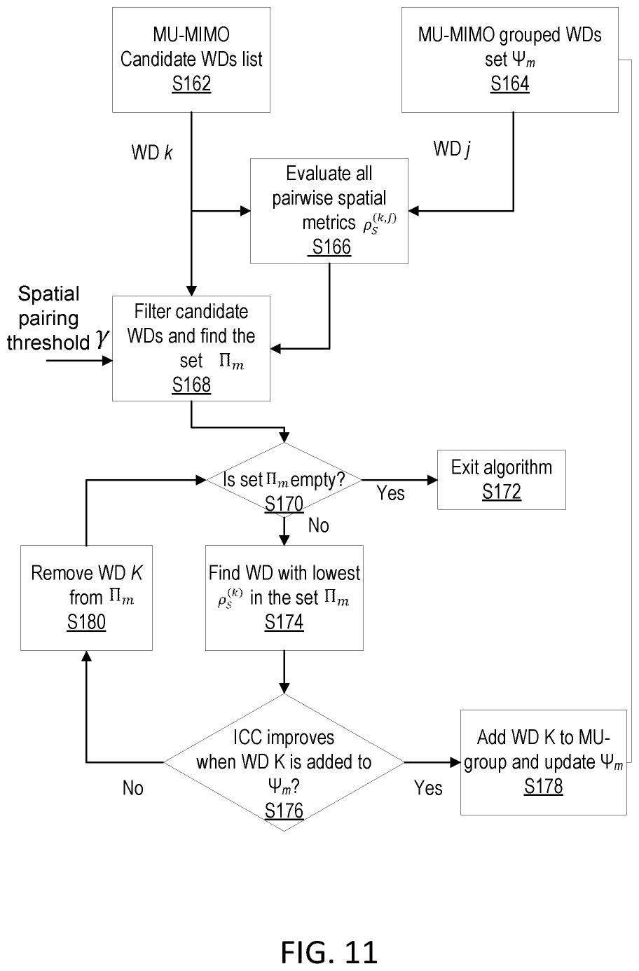

FIG. 11 is a block diagram of an example MU-MIMO grouping algorithm according to one or more embodiments of the present disclosure. The iterative pairing algorithm starts by adding such as via one or more of processing circuitry 68, processor 70, radio interface 62, grouping unit 32, etc., the wireless device 22 with the highest priority to the MU-MIMO group. At each iteration, the set of wireless device 22 candidates for co-scheduling is filtered such as via one or more of processing circuitry 68, processor 70, radio interface 62, grouping unit 32, etc., to remove the wireless devices 22 that do no pass a pairwise spatial separation test with all the wireless devices 22 in the MU-MIMO group (Block S162). Let Ψₘ denote the set of wireless devices 22 that are already in the MU-MIMO group in step m (Block S164). The spatial separation test between wireless devices k and j (i.e., wireless devices 22k and 22j) can be performed (Block S166) by determining such as via one or more of processing circuitry 68, processor 70, radio interface 62, grouping unit 32, etc., a metric ρₛ^{(k,j)} where the two wireless devices are considered to pass the test if ρₛ^{(k,j)}<γ where γ is a pre-determined threshold. Hence, wireless device 22 k passes the spatial separation test if ρₛ^{(k,j)}<γ for all j∈Ψₘ. The spatial separation test may be performed such as via one or more of processing circuitry 68, processor 70, radio interface 62, grouping unit 32, etc., by computing the correlation coefficient between the angle-of-arrival spectra of the two wireless devices 22. Let nm denote the set containing all the wireless devices 22 that passed the spatial separation pairing tests with all wireless devices 22 in the MU-MIMO group in iteration m (Block S168). A determination is performed such as via one or more of processing circuitry 68, processor 70, radio interface 62, grouping unit 32, etc., as to whether the set (Πₘ) is empty (Block S170). If the set (Πₘ) is determined to be empty, the process may end (Block S172). If the set (Πₘ) is determined to not be empty, network node 16 such as via one or more of processing circuitry 68, processor 70, radio interface 62, grouping unit 32, etc., finds the wireless device 22 with the lowest ρₛ^{(k)} in the set Πₘ, as described below (Block S174). The group pairing metric ρₛ^{(k)} for wireless device k E Πₘ is defined as a function of the pairwise pairing metrics between wireless device k and all the wireless device in the MU-MIMO group, i.e., ρₛ^{(k)}=f ({ρₛ^{(k)}}_{j∈Ψ}_{ₘ}) For example, the following can be selected

$${ρ}_{S}^{( k )} = {\sum }_{j ∈ {Ψ}_{m}} {δ}_{k , j} {ρ}_{S}^{( k , j )}$$

where δ_{k,j} is a scalar that weights the contribution of the MU-MIMO interference of wireless device k on wireless device j and can be selected based on the scheduling priority of the two wireless devices. After evaluating ρₛ^{(k)} for all k∈Πₘ, the best wireless device for MU-MIMO pairing can be determined as

$$K = {arg min}_{k ∈ {Π}_{m}} {ρ}_{S}^{( k )}$$

Afterwards, an ICC-based pairing test is performed such as via one or more of processing circuitry 68, processor 70, radio interface 62, grouping unit 32, etc., by comparing the ICC of the MU-MIMO group Ψₘ and that of Ψₘ∪{K} (Block S176). The wireless device K is added such as via one or more of processing circuitry 68, processor 70, radio interface 62, grouping unit 32, etc., to the group if the total MU-MIMO ICC of Ψₘ∪{K} is larger than that of Ψₘ (Block S178) else wireless device K is removed such as via one or more of processing circuitry 68, processor 70, radio interface 62, grouping unit 32, etc., from the set Ψₘ (Block S180) and the wireless device with the next best pairing metric is tested for ICC improvement (i.e., the process performs such as via one or more of processing circuitry 68, processor 70, radio interface 62, grouping unit 32, etc., the determination of Block S170).

Performance Evaluation

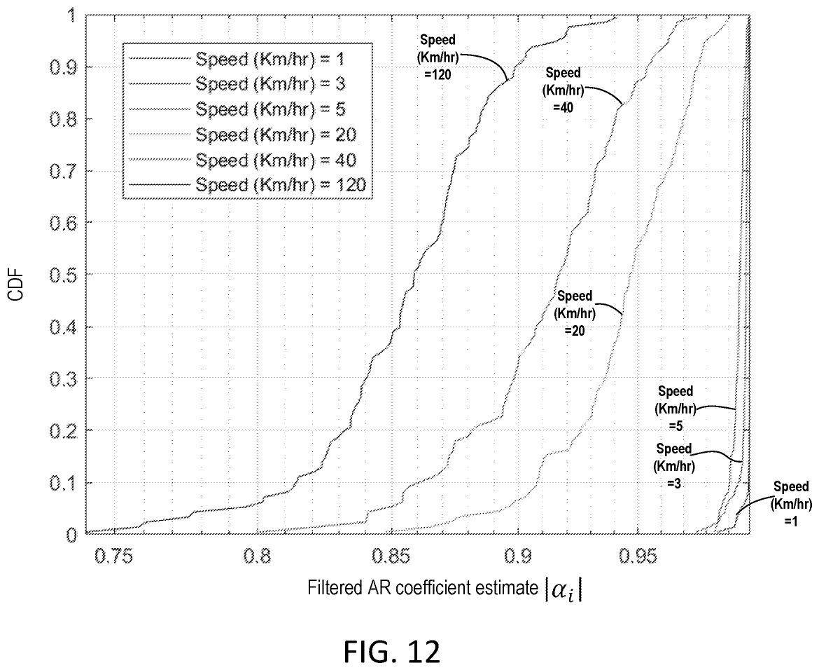

The performance of the channel variation rate estimation and MU-MIMO grouping algorithms, described herein, are illustrated in FIGS. 12-14 using system-level simulations. A 5G cellular system with bandwidth 30 MHz and carrier frequency 3.5 GHz is simulated. The system operates in time division duplex mode where the Downlink/Uplink timeslot pattern is 3/1. A single cell with radius 400 m is considered. The 5G SCM Urban Macro channel model with NLOS communication is used in this simulation. The antenna configuration at network node 16 is the AAS AIR 6488 (4×8×2) configuration and each wireless device 22 is equipped with 2 omni-directional receive antennas. Channel estimates are obtained from uplink sounding reference symbols (SRS) that are transmitted from each wireless device 22 antenna separately. The SRS period is given by 5 msec and antenna switching is employed by wireless device 22 when SRS transmissions occur. The traffic model for the downlink is selected as full buffer.

First, the accuracy of the channel variation estimation algorithm is investigated. For this purpose, the speed of one wireless device is changed and the channel variation coefficient |\tilde{α}ᵢ| from channel estimates obtained from uplink sounding reference signals are determined. FIG. 12 is a diagram of illustrating the cumulative distribution function (CDF) of the estimated channel variation coefficient. As illustrated in FIG. 12, the algorithm can provide consistent estimates of |\tilde{α}ᵢ|. As the mobility of wireless device 22 decreases, the channel experiences fewer temporal variations and the estimated value of |\tilde{α}ᵢ| gets closer to 1.

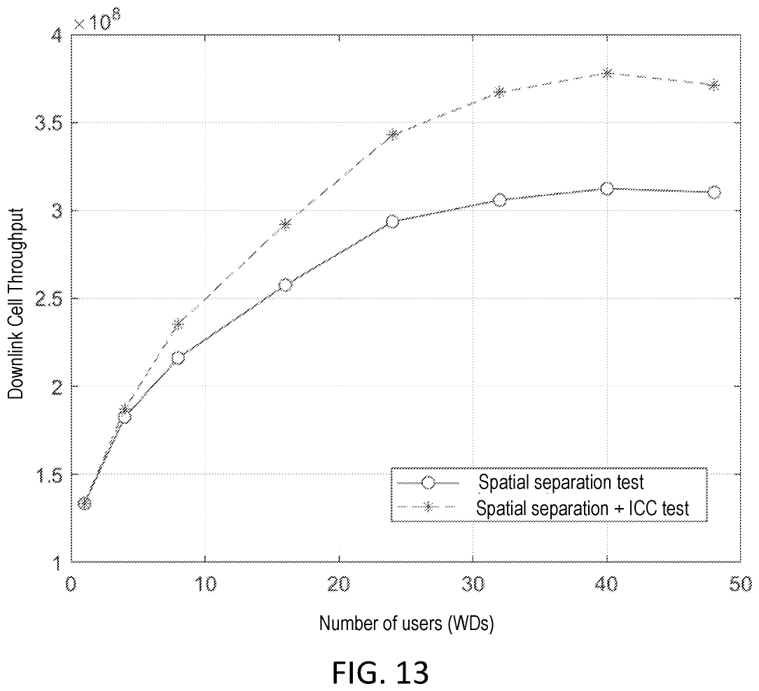

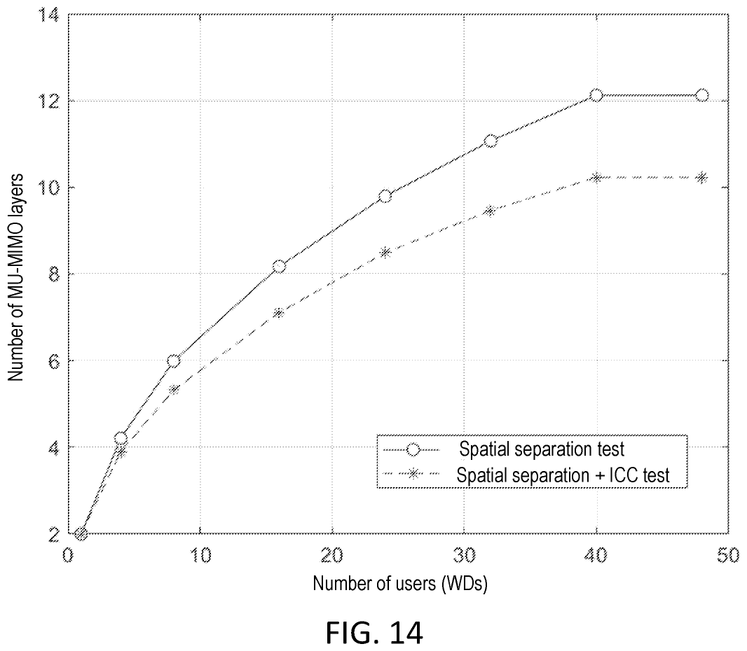

Next, the performance improvement of the ICC-based grouping algorithm is investigated. For this purpose, several wireless devices 22 are dropped randomly in the simulation area. The system performance is evaluated in terms of the downlink cell throughput. The speed of each wireless device 22 is selected randomly according to a truncated exponential distribution with maximum speed 120 Km/hr. FIG. 13 is a diagram of the downlink cell throughput of the MU-MIMO grouping algorithm, described herein, versus downlink cell throughput obtained when only spatial separation-based grouping is only employed. As illustrated in FIG. 13, the MU-MIMO grouping algorithm, described herein, provides a significant improvement in cell throughput as it is able to properly select the wireless devices 22 in the MU-MIMO group such that the ICC (and hence downlink throughput) improves when a wireless device 22 is added to the MU-MIMO group. FIG. 14 is a diagram illustrating an average number of MU-MIMO layers versus the number of wireless devices 22. The MU-MIOM grouping algorithm, described herein, yields a smaller number of paired wireless devices 22 than that obtained with spatial separation-based grouping. This can be attributed to the additional test that allows the wireless device 22 to be added to the group only if the total ICC of the MU-MIMO group increases due to the added wireless device 22. Note that even through the number of MU-MIMO layers decreases after applying the new algorithm, the paired wireless devices 22 are properly selected such that the total downlink cell throughput significantly improves as shown in FIG. 13.

Therefore, one or more embodiments of the instant application provide one or more of the following advantages:
A low-complexity algorithm/method(s) is provided that utilizes successive channel measurements to compute a temporal correlation coefficient that indicates the wireless device channel variation rate;
A low complexity formula for determining the total ICC of a MU-MIMO transmission is derived where the formula/method considers the degradation in SINR due to wireless device channel variation rate.
A MU-MIMO group selection algorithm/method is provided where the algorithm/method considers the effects of wireless device channel variation as well as the spatial separability of the wireless devices. The MU-MIMO group selection algorithm/method can provide significant throughput improvement compared to legacy spatial separation-based MU-MIMO grouping.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
Abbreviations Explanation
AR Auto-Regressive
ICC Information Carrying Capacity
MU-MIMO Multi-User Multiple Input Multiple Output
SU-MIMO Single-User Multiple Input Multiple Output
SINR Signal to Interference-plus-Noise Ratio
SNR Signal to Noise Ratio
UE User Equipment

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A network node comprising:
processing circuitry configured to:
determine an information carrying capacity, ICC, based at least on a channel variation coefficient for each of a plurality of candidate wireless devices;
determine a subset of the plurality of candidate wireless devices for Multiple-Input Multiple-Output, MIMO, grouping based at least on the ICC of a MIMO transmission to the MIMO grouping; and
cause the MIMO transmission to the MIMO grouping.

2. The network node of claim 1, wherein the determining of the subset of the plurality of candidate wireless devices is based at least on spatial separability of the plurality of candidate wireless devices.

3. The network node of claim 1, wherein the plurality of candidate wireless devices are associated with pairwise spatial metrics that meet a spatial pairing threshold.

4. (canceled)

5. The network node of claim 1, wherein the channel variation coefficient indicates a rate of change in a communication channel state.

6. The network node of claim 1, wherein the processing circuitry is configured to determine the ICC based at least on mobility estimates of the plurality of candidate wireless devices.

7. The network node of claim 6, wherein the mobility estimates are based on temporal filtering of a correlation coefficient between channel estimates at successive channel estimation instants.

8. The network node of claim 1, wherein the processing circuitry is configured to determine the ICC based at least on respective signal to noise ratio, SNR, of the plurality of candidate wireless devices.

9. The network node of claim 1, wherein the processing circuitry is configured to determine the ICC based at least on inter-wireless device interference among the plurality of candidate wireless devices.

10. The network node of claim 1, wherein the processing circuitry is configured to:
determine a total ICC for a first group of the plurality of candidate wireless devices;
modify the first group by logically adding a first wireless device of the plurality of candidate wireless devices to the first group;
determine the total ICC for the modified first group;
add the first wireless device to the subset of the plurality of candidate wireless devices based on the total ICC of the modified first group being greater than the total ICC of the first group; and
remove the first wireless device from the modified first group of the plurality of candidate wireless devices based on the total ICC of the modified first group being less than the total ICC of the first group.

11. The network node of claim 1, wherein the ICC corresponds to a number of bits that are transmittable per second per resource while meeting a target bit error rate.

12. A method implemented by a network node comprising:
determine an information carrying capacity, ICC, based at least on a channel variation coefficient for each of a plurality of candidate wireless devices;
determining a subset of the plurality of candidate wireless devices for Multiple-Input Multiple-Output, MIMO, grouping based at least on the ICC of a MIMO transmission to the MIMO grouping; and
causing the MIMO transmission to the MIMO grouping.

13. The method of claim 12, wherein the determining of the subset of the plurality of candidate wireless devices is based at least on spatial separability of the plurality of candidate wireless devices.

14. The method of claim 12, wherein the plurality of candidate wireless devices are associated with pairwise spatial metrics that meet a spatial pairing threshold.

15. (canceled)

16. The method of claim 12, wherein the channel variation coefficient indicates a rate of change in a communication channel state.

17. The method of claim 12, further comprising determining the ICC based at least on mobility estimates of the plurality of candidate wireless devices.

18. The method of claim 17, wherein the mobility estimates are based on temporal filtering of a correlation coefficient between channel estimates at successive channel estimation instants.

19. The method of claim 12, further comprising determining the ICC based at least on respective signal to noise ratio, SNR, of the plurality of candidate wireless devices.

20. The method of claim 12, further comprising determining the ICC based at least on inter-wireless device interference among the plurality of candidate wireless devices.

21. The method of claim 12, further comprising:
determining a total ICC for a first group of the plurality of candidate wireless devices;
modifying the first group by logically adding a first wireless device of the plurality of candidate wireless devices to the first group;
determining the total ICC for the modified first group;
adding the first wireless device to the subset of the plurality of candidate wireless devices based on the total ICC of the modified first group being greater than the total ICC of the first group; and
removing the first wireless device from the modified first group of the plurality of candidate wireless devices based on the total ICC of the modified first group being less than the total ICC of the first group.

22. The method of claim 12, wherein the ICC corresponds to a number of bits that are transmittable per second per resource while meeting a target bit error rate.
